(19) United States
(12) Patent Application Publication
(10) Pub. No.: US 2021/0405628 A1
(43) Pub. Date: Dec. 30, 2021

(54) METHOD AND SYSTEM FOR CONTROLLING A PROCESS OF MANUFACTURING AN ITEM

(71) Applicant: THE FABLAB S.R.L., Milano (IT)

(72) Inventors: Francesco COLORNI VITALE, Milano (IT); Stefano Maria BARBERIS, Milano (IT); Davide ANDENNA, Milano (IT)

(21) Appl. No.: 17/286,189

(22) PCT Filed: Feb. 20, 2019
(86) PCT No.: PCT/IB2019/051367

§ 371 Date: Apr. 16, 2021

(30) Foreign Application Priority Data
Oct. 18, 2018 (IT) 102018000009573

(51) Int. Cl. G05B 19/418; G06F 30/10

(52) U.S. Cl. CPC G05B 19/41885; G05B 2219/25205; G06F 30/10; G05B 19/4188

(57) ABSTRACT

A method for controlling a process of manufacturing an item includes making available an electronic control device (ECD) operatively associated with a processing apparatus and a central processing unit (CPU) connected to the ECD by a telecommunications network, transmitting, by the CPU, an encrypted message representative of a digital model of the item to be manufactured to the ECD, decrypting, by the ECD, the encrypted message to store the clear text digital model of the item, sending, by the ECD, an item processing start message with the digital model of the item to the processing apparatus, sending a message indicative of a status of advancement of processing of the item to the CPU, and, following reception of an item processing end message, sending to the ECD a message for deleting the clear text digital model of the item stored in the ECD.

### TECHNOLOGICAL BACKGROUND OF THE INVENTION

### Field of Application

The present invention relates to a method and related system for controlling a process of manufacturing an item, in particular a three-dimensional item. In greater detail, such a manufacturing process is performed by a processing apparatus from a digital model of the aforesaid item.

### Background Art

In the field of digital manufacturing realizing a wide variety of items from a digital model, for example, a two-dimensional (2D) or three-dimensional (3D) digital model, of the items themselves is known. In particular, such a digital model is generated by using dedicated software and is then processed to be then produced by digital processing apparatuses, such as, for example, 3D printers, 3D laser engraving machines, laser-cutters (which work on two-dimensional files), machining centers with numerical control cutters (CNCs) and the like.

Such digital processing apparatuses allow to produce a multiplicity of copies of the same item in different places or physically away from each other.

To this end, an executable file representative of the digital model of the item to be produced is sent to the production site equipped with the digital processing apparatus specific for the selected manufacturing.

The digital processing apparatus is then configured to manufacture the item following the directives set in the executable file of the digital model. In particular, the digital processing apparatus is provided with an appropriate electronic control unit configured for executing in sequence the commands included in the executable file mentioned above to complete a manufacturing cycle.

For example, in the case of a 3D printer, the electronic control unit of the printer is configured to execute in sequence the instructions included in a g-code file and to control the operation of the electromechanical components of the printer in charge of the manufacturing steps: heating of the printing nozzle up to the temperature set in the g-code file, coordinated movement of the x-y-z axes and of the extruder during the manufacturing, repositioning of the extruder in the “resting” position and powering off of the extruder once the manufacturing is complete.

In light of the above, if the executable file, representative of the digital model of the item to be produced, is made available to n production sites different from one another, and each production site is equipped with the same digital processing or manufacturing technology, it will be possible to produce n copies of the same item which are all the equal to one another from the same file.

Nowadays, a particularly felt problem is connected to the difficulty encountered by those who produce and hold the ownership of the digital model of the item to be realized when controlling how many copies of the same item are produced in the different production sites from the same executable file.

In fact, currently, the owner of the three-dimensional digital model of the item to be produced makes available the executable file to a manufacturer authorized to produce the physical item only on the basis of the trust placed on the work of the manufacturer him or herself.

Thereby, the owner of the digital model of the item is not capable of knowing beforehand or of controlling how many copies of the same item will actually be made from the same file.

Furthermore, the owner of the digital model of the item may not prevent unauthorized manufacturers from obtaining the executable file of the digital model of the item, producing copies of the item itself, without his or her knowledge.

### SUMMARY OF THE INVENTION

Therefore, it is the object of the present invention to provide a method for controlling a manufacturing process, in particular performed by at least one processing apparatus on the basis of a digital model of the item to be manufactured, having such features so as to obviate the drawbacks described with reference to the known methods currently in use.

This and other objects are achieved by a method for controlling a manufacturing process, in particular performed by at least one processing apparatus on the basis of a digital model of the item to be manufactured, in accordance with claim 1.

In a particular embodiment, such an item to be manufactured is three-dimensional and the digital model of the item is a three-dimensional digital model.

With reference to the application in processing apparatuses consisting of 3D printers for producing three-dimensional items with additive technology, it is the object of the proposed invention to make the 3D digital model of the item to be manufactured reproducible only once on each printer, monitoring and checking the program file representative of such a digital model of the item while it is being executed, from the beginning to the end of the code.

In other words, it is the object of the invention to ensure that from each file of the digital model of the item it is possible to produce a single copy of the item itself by means of the 3D printer or, alternatively, a pre-set and controllable number of copies.

The relationship between the owner of the file and the producer of the item, therefore, is no longer based on trust, but on a method which allows to authorize, monitor and finally delete each file of the digital model of the item after use.

The present invention also relates to a system, according to claim 14, for controlling a manufacturing process configured to implement the method of the invention.

Preferred and advantageous embodiments are the subject of the dependent claims.

### BRIEF DESCRIPTION OF THE DRAWINGS

Further features and advantages of the method and system for controlling a manufacturing process in accordance with the invention will become apparent from the following description of preferred embodiments, given by way of indicative and non-limiting example, with reference to the accompanying drawings, in which:

FIG. 1 diagrammatically shows a system for controlling a manufacturing process implementing the control method of the invention;

FIG. 2 shows, by means of a block diagram, a first embodiment of an electronic control device which may be employed in the system in FIG. 1;

FIG. 3 shows, by means of a block diagram, a second embodiment of an electronic control device which may be employed in the system in FIG. 1;

FIG. 4 shows, by means of a flow diagram, a method for controlling a manufacturing process, in particular implemented by the system in FIG. 1;

FIGS. 5A-5B show embodiments of some steps of the method for controlling a manufacturing process in FIG. 4.

In the aforesaid Figures, equal or analogous elements are indicated by means of the same reference numerals.

### DETAILED DESCRIPTION

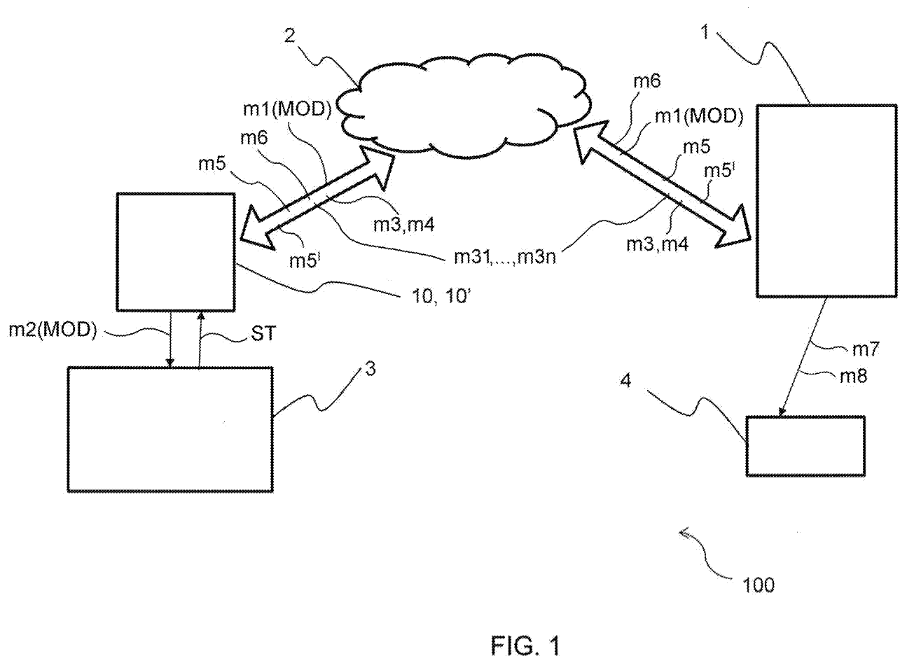

With reference to FIG. 1, a system for controlling a process of manufacturing an item implementing the control method 400 of the invention is overall indicated with reference numeral 100.

In particular, such a manufacturing is performed by at least one processing apparatus 3 on the basis of a digital model MOD of the item to be manufactured.

In a particular embodiment of the invention, such an item to be manufactured is a three-dimensional item built from a three-dimensional digital model of the item itself.

Even though the embodiments described below explicitly refer to the process of manufacturing a three-dimensional item obtained from a 3D digital model, the results and the advantages of the present invention are equally applicable to the case of the manufacturing of two-dimensional (2D) items, for example shaping, embossing, molding or engraving processes performed by laser cutter.

The aforesaid manufacturing control system 100 will be indicated below as control system or, more simply, system.

The system 100 comprises at least one processing apparatus 3 configured to perform the manufacturing process. Such a processing apparatus 3 is a digital processing apparatus, for example, selected from the group consisting of: 3D printer, 3D laser engraving machine, laser-cutter, machining center with numerical control cutters (CNCs) and similar processing apparatuses.

In a preferred and non-limiting embodiment of the present invention, the processing apparatus 3 is embodied by a 3D printer configured to produce three-dimensional items by means of additive production techniques, from a three-dimensional (3D) digital model of the item. As known, such a digital model MOD is produced with dedicated software and then processed to be then obtained, layer by layer, by means of the 3D printer.

Furthermore, the system 100 comprises an electronic control device 10, 10′ operatively associated with at least one processing apparatus 3.

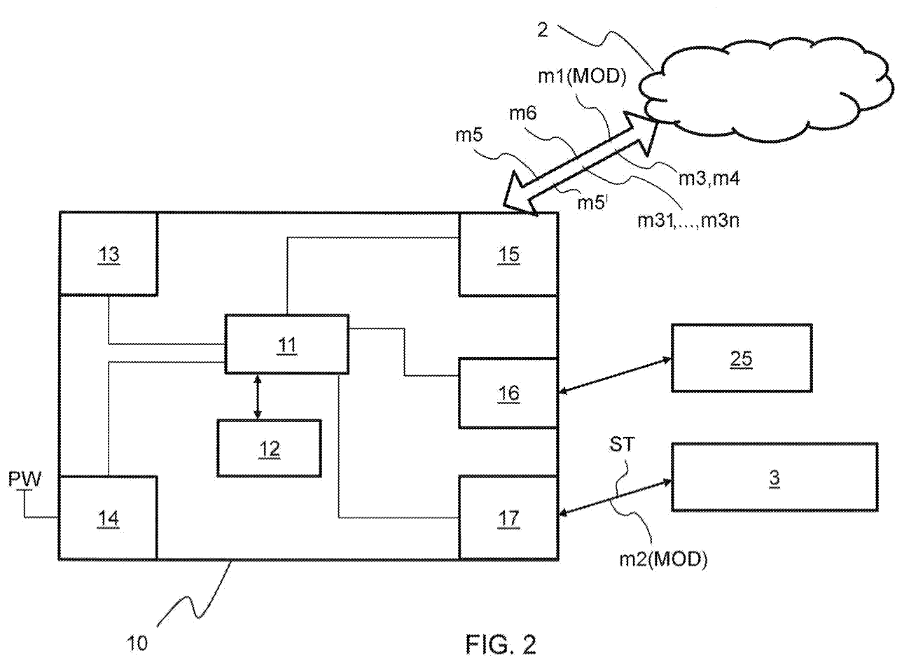

With reference to FIG. 2, in a first embodiment, the electronic control device 10 is a stand-alone type hardware device electrically connected to the at least one processing apparatus 3, in particular to the 3D printer.

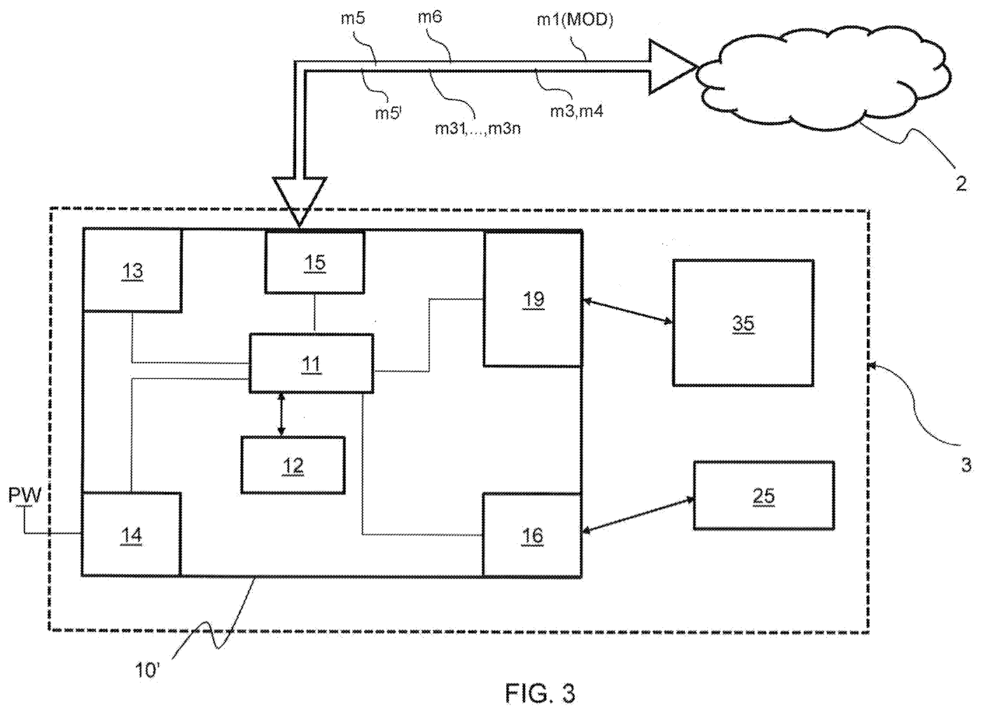

With reference to FIG. 3, in a second embodiment, the electronic control device 10′ is an embedded-type hardware device, i.e., integrated into the at least one processing apparatus 3. In other words, the electronic control device 10′ constitutes a control component of the printer 3 itself, configured to control the electromechanical components 35 of the printer in charge of the processing steps: motor, printing nozzle, axes x-y-z for moving the extruder during the process, etc.

In addition, the system 100 comprises a central processing unit 1 connected to the aforesaid electronic control device 10, 10′ by means of a telecommunications network 2, for example, the Internet.

In an embodiment, the central processing unit 1 is embodied by a server apparatus (Core Server) operating in a cloud computing configuration and connectible to the electronic control device 10, 10′ by means of a Virtual Private Network (VPN). Such a Virtual Private Network is encrypted, for example, with Transport Layer Security (TLS) and Secure Sockets Layer (SSL) cryptographic protocols.

Such a server apparatus 1 comprises, for example, a first data storage block, in particular a non-volatile type memory, configured to store a plurality of digital models MOD of the items to be manufactured and the related code files generated from such digital models. Furthermore, the server apparatus 1 comprises a second data storage block, in particular a further non-volatile type memory, configured to store the code instructions of a respective control method management software of the invention which will be described in detail below.

With reference to FIGS. 2-3, the aforementioned electronic control device 10, 10′ comprises a processing block 11 including at least one processor and one service memory, of the volatile type (for example SDRAM), associated with the processor for storing instructions.

Such a processing block 11 is connected to a non-volatile type system memory 12 (for example of the SSD type).

Furthermore, the electronic control device 10, 10′ comprises a plurality of data communication interfaces 13, 15, 16, 17, 19, each of which is connected to the processing block 11.

In greater detail, the electronic control device 10, 10′ comprises:
a data communication interface 13 of the wired type, for example, the Ethernet;
a wireless data communication interface 15, for example Wi-Fi, configured to connect the electronic control device 10, 10′ to the Internet 2, to enable the electronic device to communicate with remote electronic devices, such as, for example, the server 1;
a wired data communication interface 16, for example, a High-Definition Multimedia Interface or HDMI, to connect the electronic control device 10, 10′ with a video camera 25.

With particular reference to the example in FIG. 2, the electronic control device 10 also comprises a USB or serial type interface (PCI Express) for the connection to the 3D printer 3. Instead, with reference to the example in FIG. 3, the electronic control device 10′ which is integrated in the 3D printer, comprises an INPUT/OUTPUT interface, for example digital and analog pins for connecting the processing block 11 to the electromechanical components 35 of the printer 3.

In addition, the electronic control device 10, 10′ comprises a power supply block 14 connectible to a power supply source PW. Such a power supply block 14 is configured to supply a direct current voltage, for example, 5V, to all the circuit blocks of the electronic control device 10, 10′.

In an embodiment, the control system 100 shown in FIG. 1 also comprises a portable user device 4 connectible to the central processing unit 1, i.e., to the Core Server, by means of a mobile radio telecommunications network. For example, such a portable user device 4 is embodied by a smartphone, a tablet or a laptop associated with one or more users.

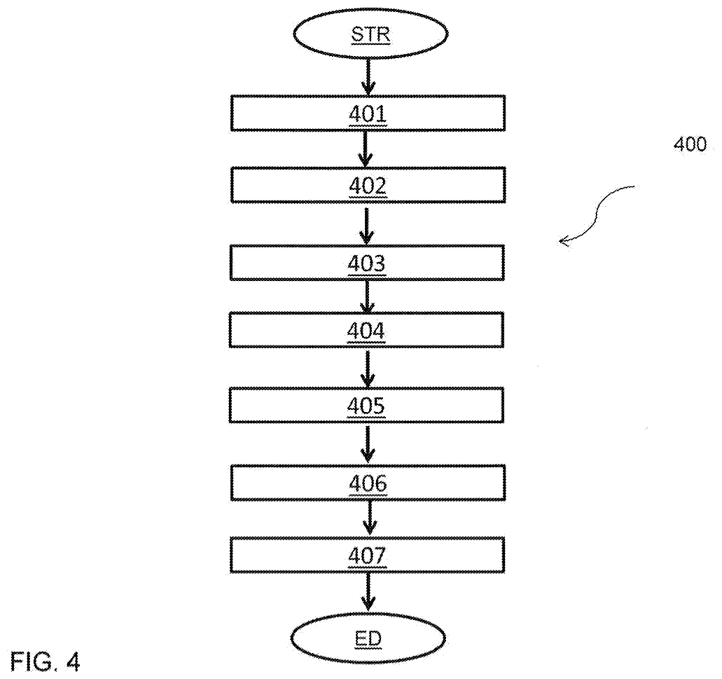

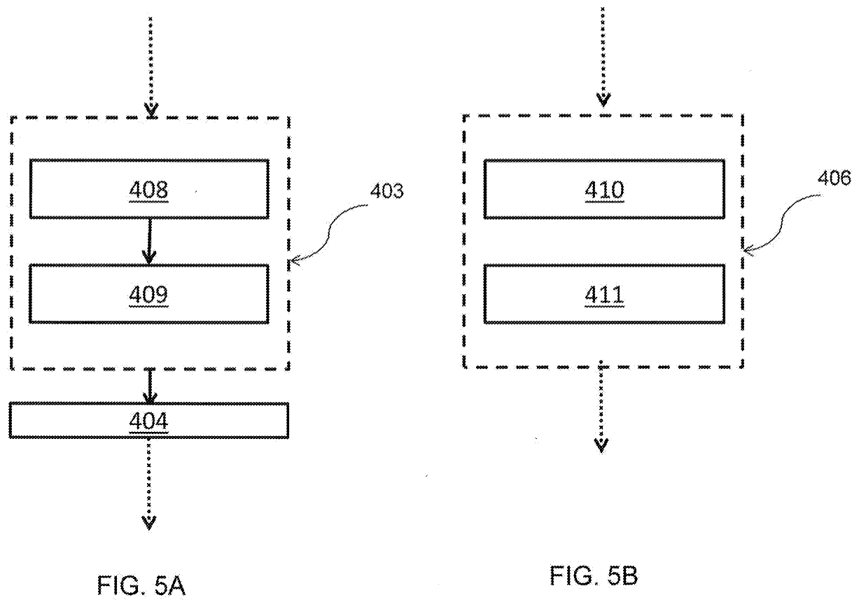

With reference to FIGS. 4, 5A, 5B, the operating steps of the method 400 for controlling a manufacturing process, in particular performed by at least one processing apparatus 3 on the basis of a digital model, in particular three-dimensional, of the item to be manufactured, implemented by the system 100, are described below in greater detail.

In an embodiment, both the central processing unit 1 and the processing block 11 of the electronic control device 10, 10′ are arranged so as to execute the codes of an application program, in particular a web application, implementing the method 400 of the invention.

The method 400 comprises a symbolic starting step STR and a symbolic ending step ED.

In the most general embodiment, the method 400 for controlling a manufacturing process comprises the preliminary steps of making available 401 an electronic control device 10, 10′ operatively associated with at least one processing apparatus 3, i.e., with the 3D printer, and of making available 402 a central processing unit 1 connected to the electronic control device 10, 10′ by means of a telecommunications network 2, for example, the Internet.

Again with reference to the aforesaid preliminary steps, in a non-limiting embodiment, the method 400 comprises a step of converting the digital model MOD of the three-dimensional item to be manufactured into a file F of software code instructions executable by the at least one processing apparatus 3. The aforesaid file F is, for example, a G-code file.

After that, the method includes a step of sending such a file of instructions F to the central processing unit 1 to be stored in a mass memory of such a unit.

Having said this, it should be noted that below reference will be made to the digital model MOD of the item to be manufactured, indicating with it also the related file F of software code instructions executable by the processing apparatus 3.

The method 400 of the invention comprises a step of transmitting 403, by means of the central processing unit 1, an encrypted message m1 to the electronic control device 10, 10′. In particular, such an encrypted message m1 is representative of a digital model MOD of the three-dimensional item to be manufactured.

In greater detail, the aforesaid step of transmitting 403 the encrypted message m1 comprises a step of encrypting 408 the digital model MOD of the three-dimensional item to be manufactured by means of an asymmetric cryptographic algorithm using a public key to generate said encrypted message m1.

For example, such an asymmetric cryptographic algorithm is the GnuPG or GPG algorithm.

The step of transmitting 403 the encrypted message m1 also comprises a step of sending 409 the encrypted message m1 to the electronic control device 10, 10′.

The method 400 also comprises a step of decrypting 404, by means of the electronic control device 10, 10′, the encrypted message m1 to store the clear text digital model MOD of the three-dimensional item, in particular, in the system memory 12 of such a device. It should be noted that such a step of decrypting 404 the encrypted message m1 is performed by means of a private key of the aforesaid asymmetric cryptographic algorithm.

In addition, the method comprises a step of sending 405, by means of the electronic control device 10, 10′, a three-dimensional item processing start message m2 to the at least one processing apparatus 3. It should be noted that such a start message m2 comprises at least the decrypted digital model MOD of the three-dimensional item. Optionally, such a start message m2 may additionally comprise commands to start the processing.

The method 400 further comprises a step of sending 406, by means of the electronic control device 10, 10′, at least one message m3 indicative of the status ST of advancement of the processing of the three-dimensional item to the central processing unit 1. In other words, on the basis of a respective status ST signal sent by the 3D printer 3, the electronic control device 10, 10′ provides one or more messages m3 indicative of the status of advancement of the printing of the three-dimensional item.

In an embodiment of the method 400, the aforesaid step of sending 406 at least one message m3 of the status of advancement of the processing of the three-dimensional item comprises the step of sending 410, by means of the electronic control device 10, 10′, a plurality of messages m31, m32, . . . , m3n at a pre-set time interval T from one another.

In a particular embodiment, such a time interval T is 10 seconds.

In a different embodiment, such a time interval T may be greater than 10 second.

Following the reception of a three-dimensional item processing end message m4, the method 400 of the invention comprises, advantageously, a step of sending 407 to the electronic control device 10, 10′, by means of the central processing unit 1, a message for deleting m5 the clear text digital model MOD of the three-dimensional item stored in the electronic control device 10, 10′.

In other words, with the method for controlling the manufacturing process of the invention, the digital model MOD of the item to be produced is sent securely to the 3D printer 3 and is made reproducible only once. Furthermore, the method allows to monitor and control the file F of instructions of code representative of such a digital model of the item while it is being executed on the printer 3.

In an embodiment of the invention, if an event of disconnection of the electronic control device 10, 10′ from the telecommunications network 2 occurs, the method 400 comprises a step of generating, by means of the central processing unit 1, a further message for deleting m5′ the clear text digital model MOD of the item to be sent to the electronic control device 10, 10′. In particular, such a further deleting message m5′ is sent once the connection between the central processing unit 1 and the electronic control device 10, 10′ is restored.

Such a protection function is designed to counter fraudulent attempts to disconnect the electronic control device 10, 10′ from the network 2.

In a further embodiment, the aforesaid step of sending 406 at least one message of the status of advancement of the processing of the three-dimensional item to the central processing unit 1 comprises a further step of sending 411 to the central processing unit 1, by means of the electronic control device 10, 10′, at least one operational status message m6. Such an operational status message m6 is representative of a condition of disconnection of the electronic control device 10, 10′ from the power supply source PW.

Such a protection function is designed to counter fraudulent attempts to disconnect the electronic control device 10, 10′ from the power supply source PW.

In an advantageous embodiment, following the sending, by means of the electronic control device 10, 10′, of the at least one message m3 of the status of advancement of the processing of the item, the method 400 comprises a step of sending, by means of the central processing unit 1, a first status notification message m7 to the portable user device 4.

Thereby, the user is capable of following, remotely and substantially in real time, the progress in the production of the item with the 3D printer.

In addition, if an event of disconnection of the electronic control device 10, 10′ from the telecommunications network 2 occurs, or in case of reception of the at least one operational status message m6 signaling a condition of disconnection of the electronic control device from the power supply source PW, the method 400 comprises a step of sending, by means of the central processing unit 1, a second status notification message m8 to the portable user device 4.

Thereby, the user is notified, substantially in real time, about possible interruptions in the process of manufacturing the item with the 3D printer.

In the present invention, the term user is used to indicate both the operators in charge of the digital processing apparatuses 3 and all those users of the system 100 authorized to access the control system 100 by means of the central server 1.

Furthermore, the method 400 comprises the steps representative of a selection of the digital model MOD which is desired to be produced by the 3D printer.

In particular, a step of establishing a communication between the central processing unit or server 1 and the portable user device 4 is provided. Such a communication is established, for example, by means of a user authentication on the server 1 which uses an accounting procedure.

Thereby, the user may purchase, by means of the portable device 4 thereof, one or more digital models MOD of the three-dimensional item to be manufactured stored in the central processing unit 1.

Furthermore, for each of these one or more digital models MOD acquired, the method provides that the user may also select the number of repetitions N of the processing which may be performed from the same digital model. To this end, a counter, configured to store the number of selected processing repetitions which may be performed, will be generated in the server 1.

At this point, the method 400 includes a step of updating the number of processing repetitions stored in the counter following the reception, by means of the central processing unit 1 of the end message m4 of each of the three-dimensional item processing repetitions.

It should be noted that such a step of updating is performed before the above described step of sending 407 to the electronic control device 10, 10′ the message for deleting m5 the clear text digital model MOD of the three-dimensional item.

As noted above, the method 400 for controlling a manufacturing process, in particular performed by a processing apparatus 3 on the basis of a digital model MOD of the item to be manufactured, and the related control system 100 of the present invention have numerous advantages and achieve the intended goals.

In particular, the control method of the invention ensures that from each file F of the digital model MOD of the three-dimensional item it is possible to produce only one copy of the same item by means of the 3D printer. At most, it will be possible to produce a pre-set and controllable number of copies.

Therefore, unlike the known solutions, the relationship between the owner of the digital model MOD of the item to be reproduced and the producer of the item itself, is based on a method which allows to authorize the execution of a file of the digital model MOD of the item, monitor the steps of processing the item thereof and finally delete each file of the model MOD after use.

Furthermore, by means of the web application of the invention it is possible to verify in real time the advancement of the printing and to manage all the main functions of the 3D printer 3, such as start, pause, stop, extruder temperature and speed.

Such a monitoring occurs both by means of the messages m3 of the status of advancement and by means of a video stream which uses the video camera 25 connected to the electronic control device 10, 10′.

Furthermore, as shown above, in the case of disconnection of the control device 10, 10′ from the network 2 during the execution of a printing, a warning notification will be sent to the user by means of the central server 1. Once the connection is restored, the electronic control device 10, 10′ is configured to communicate the status of advancement of the printing: in case of completion of the processing, the file of the digital model MOD is deleted or the counter of the three-dimensional item copies to be produced is decremented.

In any case, a new processing may not be started until the connection to the network 2 is restored. Thereby, unauthorized use of the file of the digital model MOD is prevented.

In case of repeated disconnections from the network 2 by means of the electronic control device 10, 10′, the server 1 is configured to temporarily disable the use of the specific control device which is subjected to such disconnections.

Similarly, the lack of electrical power to the electronic control device 10, 10′, effectively inhibits the use of the processing apparatus 3 which this is associated with: this prevents the file of the digital model MOD from being used in an unauthorized manner. In case of repeated shutdowns and reboots of the electronic control device 10, 10′, the server 1 is configured to temporarily disable the use of the specific control device which is subjected to such shutdowns.

Each of the individual features described by way of explanation in combination with other features is to be understood as described also in an independent and isolated manner and, therefore, also applicable to the other embodiments described of the method and system for controlling a manufacturing process of the invention. These embodiments with features isolated or in combination with features of other embodiments are expressly contemplated but not described herein for brevity.

1. A method for controlling a manufacturing process of an item, wherein said manufacturing process is performed by at least one processing apparatus, the method comprising the steps of:
making available an electronic control device operatively associated with said at least one processing apparatus;
making available a central processing unit connected to said electronic control device by a telecommunications network;
transmitting, by said central processing unit, an encrypted message to the electronic control device, said encrypted message being representative of a digital model of the item to be processed;
decrypting, by the electronic control device, the encrypted message to store a clear text digital model of the item;
sending, by the electronic control device, an item processing start message to the at least one processing apparatus, said item processing start message comprising at least the decrypted digital model of the item;
sending, by the electronic control device, at least one message indicative of a status of advancement of the processing of the item to the central processing unit; and
following reception of an item processing end message, sending to the electronic control device, by the central processing unit, a message for deleting the clear text digital model of the item stored in the electronic control device.

2. The method of claim 1, wherein said item to be manufactured is three-dimensional and said digital model of the item is a three-dimensional digital model.

3. The method of claim 1, wherein said step of transmitting an encrypted message by the central processing unit comprises the steps of:
encrypting the digital model of the item to be manufactured by an asymmetric cryptographic algorithm using a public key to generate said encrypted message,
sending the encrypted message to the electronic control device,
and wherein said decrypting step comprises a step of decrypting the encrypted message by the electronic control device by a private key of the asymmetric cryptographic algorithm.

4. The method of claim 1, wherein said step of sending at least one message indicative of a status of advancement of the processing of the item to the central processing unit comprises a step of sending, by the electronic control device, a plurality of messages at a pre-set time interval one to the other.

5. The method claim 4, wherein said pre-set time interval is 10 seconds.

6. The method of claim 1, wherein, following an occurrence of an event of disconnection of the electronic control device from the telecommunications network, the method comprises a step of generating, by the central processing unit, a further message for deleting the clear text digital model of the item to be sent to the electronic control device once connection between the central processing unit and the electronic control device is restored.

7. The method of claim 1, wherein said step of sending at least one message indicative of a status of advancement of the processing of the item to the central processing unit further comprises an additional step of sending to the central processing unit, by the electronic control device, at least one operational status message representative of a condition of disconnection of the electronic control device from a power supply source.

8. The method of claim 1, wherein, following the sending, by the electronic control device, of the at least one message indicative of a status of advancement of the processing of the item, the method comprises a step of sending, by the central processing unit, a first status notification message to a portable user device.

9. The method of claim 6, wherein, following the occurrence of an event of disconnection of the electronic control device from the telecommunications network or upon reception of the at least one operational status message representative of a condition of disconnection of the electronic control device from a power supply source, the method comprises a step of sending, by the central processing unit, a second status notification message to the portable user device.

10. The method of claim 1, further comprising the steps of:
converting said digital model of the item to be manufactured into a file of software code instructions executable by the at least one processing apparatus; and
sending said file of software code instructions to the central processing unit to be stored in a mass memory of said central processing unit.

11. The method of claim 1, further comprising the steps of:
establishing a communication between the central processing unit and the portable user device;
acquiring, by the portable user device, one or more digital models of the item to be manufactured stored in the central processing unit;
for each of said one or more acquired digital models, selecting a number of processing repetitions performable starting from a same digital model;
generating, in said central processing unit, a counter configured to store the number of selected processing repetitions performable starting from the same digital model;
updating the number of processing repetitions stored in said counter following reception, by the central processing unit, of the item processing end message of each of the processing repetitions, said updating step being performed before the step of sending to the electronic control device the message for deleting the clear text digital model of the item.

12. The method of claim 1, wherein said electronic control device is a stand-alone type hardware device electrically connected to said at least one processing apparatus.

13. The method of claim 1, wherein said electronic control device is an embedded-type hardware device integrated in said at least one processing apparatus.

14. A system for controlling a manufacturing process of an item, the system comprising:
at least one processing apparatus configured to perform said manufacturing process;
an electronic control device operatively associated with said at least one processing apparatus; and
a central processing unit connected to said electronic control device by a telecommunications network;
said system being configured to perform a method for controlling a manufacturing process of an item, the method comprising the steps of:
transmitting, by said central processing unit, an encrypted message to the electronic control device, said encrypted message being representative of a digital model of the item to be processed;
decrypting, by the electronic control device, the encrypted message to store a clear text digital model of the item;
sending, by the electronic control device, an item processing start message to the at least one processing apparatus, said item processing start message comprising at least the decrypted digital model of the item;
sending, by the electronic control device, at least one message indicative of a status of advancement of the processing of the item to the central processing unit; and
following reception of an item processing end message, sending to the electronic control device, by the central processing unit, a message for deleting the clear text digital model of the item stored in the electronic control device.

15. The system of claim 14, further comprising a portable user device connectible to the central processing unit by a mobile radio telecommunications network.

16. The system of claim 14, wherein said electronic control device is a standalone type hardware device electrically connected to said at least one processing apparatus.

17. The system of claim 14, wherein said electronic control device is an embedded-type hardware device integrated in said at least one processing apparatus.

18. The system of claim 14, wherein said at least one processing apparatus is selected from the group consisting of: 3D printer, 3D laser engraving machine, laser-cutter, machining center with numerical control cutters.
